(19) United States
(12) Patent Application Publication
(10) Pub. No.: US 2026/0000927 A1
(43) Pub. Date: Jan. 1, 2026

(54) Adjustable Trampoline

(71) Applicant: ACON FINLAND OY LTD, Oulu (FI)

(72) Inventors: Tapio Mäkelä, Kempele (FI); Timo Luhtaniemi, Oulu (FI); Jari Kiviniemi, Siikajoki (FI); Joel Sallinen, Liminka (FI)

(73) Assignee: ACON FINLAND OY LTD, Oulu (FI)

(21) Appl. No.: 19/127,119

(22) PCT Filed: Oct. 27, 2023
(86) PCT No.: PCT/FI2023/000007

§ 371 Date: May 4, 2025

(30) Foreign Application Priority Data
Nov. 4, 2022 (FI) 20227137

(51) Int. Cl. A63B 5/11; A63B 21/02; A63B 21/04

(52) U.S. Cl. CPC A63B 5/11; A63B 21/023; A63B 21/0428

(57) ABSTRACT

This disclosure relates to a trampoline that comprises a frame, a mat, a plurality of spring elements arranged between the mat and the frame, and a plurality of fastener members. The fastener member comprises an anchor point of the spring element and the mat comprises a plurality of fabric loops with at least two casings that are arranged to receive the N fastener members. The tension of the mat can be adjusted by the changing the placing of at least some of the fastener members between the casings or adding more fasteners and springs.

### CROSS REFERENCE TO RELATED APPLICATIONS

This application is a national phase application of international application PCT/FI2023/000007, filed 27 Oct. 2023, which claims priority to Finnish patent application 20227136, filed Nov. 4, 2022, the content of the both of which are herein incorporated by reference.

### BACKGROUND OF THE INVENTION

### Field of the Invention

The invention relates to a trampoline comprising a frame, a mat, and a plurality of spring elements arranged between the mat and the frame, and the spring element comprises a mat end and a frame end, and the mat comprises a plurality of attaching members at the edge of the mat, the trampoline further comprises a plurality of fastener members arranged between the adjacent attaching members and the fastener member comprises an anchor point for the mat end of the spring element.

### Description of Related Art

Trampolines are commonly used in outdoor and indoor activities. Trampolines comprise a frame and a rebounding mat connected to the frame with stretching elements such as springs or similar. There are different types of trampolines for different use. Trampolines for recreational use are generally used at home in backyards for jumping exercises and stunts on the said device. Such outdoor trampolines come in many shapes and sizes; however, most are circular or rectangular with a diameter of 3 to 5 meters and the mat of said devices is located at least 60 to 100 centimeters above the ground.

The jumping characteristics and the rebound dynamics of a trampoline are generally determined by the characteristics of the chosen springs and the tautness of the mat. The tautness of the mat depends generally on the number and the pre-tensioning of the springs. The springs are used to store and release the potential energy from the landing to launch the jumper back into the air. Typically, users attempt to jump as high as possible, which means that it's desirable that the deflection rate of the mat is high during landing. For optimal rebound dynamics, it may be desirable to adjust the tension of the springs and/or adjust a tautness of the mat for users with different body weight or skills. Heavy users may want to adjust the tautness of the mat to decrease the deflection rate of the mat and prevent it from hitting the ground. However, a mat adjusted for heavy users may not suit lighter users, because the deflection rate of the mat may be insufficient, and the high tension of the mat may cause on-mat impact injuries. A mat under less tension is safer because it absorbs the impact slower. In addition, the tension of the springs may need to be adjusted due to the inelastic deformation of the springs that occurs over time. Thus, it would be advantageous to have a trampoline in which the tension of the springs and the tautness of the mat can be easily adjusted. With most current designs, the springs must be replaced to adjust the spring tension. This is not an easy method and requires various set of springs. In some trampolines, the tensions of the springs can be adjusted by altering the dimensions of the frame. Such trampoline frame structures are, for example, disclosed by patent publications NL8702095A and U.S. Pat. No. 10,722,744B2. However, such frame structures are cumbersome and complex to manufacture and assemble. Some trampolines comprise adjustable springs, such as disclosed by patent publications U.S. Pat. No. 4,162,063A and U.S. Pat. No. 10,245,457B2, but these are likewise cumbersome to manufacture and use. In some trampolines, the tensions of the springs can be adjusted by changing the anchor point of the spring element. Such trampolines are, for example, disclosed by patent publications U.S. Pat. No. 6,840,891 B2, DE202014105922U1 and U.S. Pat. No. 9,993,676B2. However, the adjusting possibilities described in the publications are somewhat limited and require complex or various sets of fastener elements.

There is a clear need for a trampoline, in which the tension of the springs and the tautness of the mat can be easily and flexible adjusted.

### BRIEF SUMMARY OF THE INVENTION

The object of the invention is a solution that can significantly reduce the disadvantages and drawbacks of the prior art. In particular, the object of the invention is an improved solution where a device is trampoline that is easy manufacture and in which the tension of the springs and the tautness of the mat can be easily and flexible adjusted.

The objects of the invention are attained with a device that is characterized by what is stated in the independent patent claim. Some advantageous embodiments of the invention are disclosed in the dependent claims.

The invention is a trampoline comprising a frame, a mat, and a plurality of spring elements arranged between the mat and the frame. The mat comprises a plurality of attaching members on the edge of the mat. The trampoline further comprises a plurality of fastener members arranged between the adjacent attaching members. The fastener member comprises an anchor point of the spring element. At least some of the attaching members comprise at least two casings that are arranged to receive the fastener members. The casings are configured in such a way that the distance from the inner casing to the frame is longer than the distance from the outer casing to the frame. When reference is made in the text to the upper or the lower parts or respective directions such as down or up, or vertical or horizontal directions, a situation is described in which the trampoline according to the invention is in use. Also, when reference is made to the front, rear, top or side parts or directions, the trampoline is placed similarly and in such a way that the front side is generally used for jumping on the trampoline, and in case of a rectangular trampoline, the side is the longer side of the rectangular. When reference is made to the internal or external sides, the trampoline is placed similarly, and the internal side is facing towards the center of the mat and the external side is facing outwards the center of the mat.

The present invention relates to a trampoline comprising a frame, a mat, and a plurality of spring elements arranged between the mat and the frame, and the spring element comprises a mat end and a frame end, and the mat comprises a plurality of attaching members on the edge of the mat, the trampoline further comprises a plurality of fastener members and the fastener member comprises an anchor point for the mat end of the spring element. In one advantageous embodiment of the invention, at least some of the attaching members comprise two casings: an outer casing and an inner casing. The casings are arranged to receive the fastener members, and the casings are configured in such a way that the distance from the inner casing to the frame is longer than the distance from the outer casing to the frame. The fastener member is set into corresponding casings, i.e. outer casings, or inner casings, of the adjacent attaching members. The anchor point is between said adjacent attaching members.

In an embodiment of the trampoline, the fastener member is an elongated bar having a first end of the fastener member and a second end of the fastener member. The fastener member comprises at least three folds positioned in such a way that the folded fastener member is substantially in the same plane, and the folds are a center fold and two side folds on both sides of the center fold.

In a second embodiment of the trampoline, the center fold and the side folds of the fastener member are configured in such a way that the distance between the side folds is substantially shorter than the distance between two adjacent attaching members.

In a third embodiment of the trampoline, the fold has an angle of the fold, and the angle of the fold is the angle of the fastener member parts adjacent to the fold, and the sum of the angles of the side folds is substantially equal to the angle of the center fold. In some embodiments, the first end of the fastener member and the second end of the fastener member are pointing substantially in opposite directions. In a fourth embodiment of the trampoline, the angle of the center fold is between 30 and 45 degrees.

In a fifth embodiment of the trampoline, the anchor point is at the center fold.

In a sixth embodiment of the trampoline, the fastener member comprises two end folds configured in such a way that the distance between the end folds is longer than the distance between two adjacent attaching members.

In a seventh embodiment of the trampoline, the angle of the end fold is between 15 and 30 degrees.

In an eighth embodiment of the trampoline, the folds of fastener member are configured to form curves on the fastener member and said curves curve towards the frame when the fastener member is positioned into the casings.

In a nineth embodiment of the trampoline, the fastener member is arranged between the adjacent attaching members either into the inner casings or the outer casings, and the fastener member is configured to be detachable so that the placing of the fastener member is interchangeable.

In a tenth embodiment of the trampoline, the tension of the mat is altered by changing the placing of at least some of the fastener members between the inner casings and the outer casings, so that the distance of the fastener member and the anchor point of the spring element changes in respect to the frame.

In an eleventh embodiment of the trampoline, the tension of the mat is altered by changing the number of spring elements and the tension is increased by arranging fastener members in at least some of every other space between adjacent attaching members, so that the adjacent fastener members are not occupying the same casings.

In a twelfth embodiment of the trampoline, the fastener member is a steel bar.

In a thirteenth embodiment of the trampoline, the attaching member comprise a fabric loop sewn on the edge of the mat. In a fourteenth embodiment of the trampoline, the fabric loop of the attaching member has at least two layers of fabric and the casings are formed between said layers.

An advantage of the invention is that the bouncing properties of a trampoline can be adjusted fast and easily.

It is an advantage of the invention that it improves the stability and durability of a trampoline. Also, safety is improved. It is a further advantage of the trampoline that it is easy to manufacture and can be easily and flexibly adjusted for different users.

### BRIEF DESCRIPTION OF THE SEVERAL VIEWS OF THE DRAWINGS

Further advantageous features and details of the various embodiments of this disclosure will become apparent from the ensuring description of a preferred exemplary embodiment or embodiments and further with the aid of the drawings. The features and combinations of features recited below in the description, as well as the features and feature combination shown after that in the drawing description or in the drawings alone, may be used not only in the particular combination recited by also in other combinations on their own without departing from the scope of the disclosure.

FIG. 1 shows an example of a trampoline according to an embodiment,

FIG. 2 shows one adjustment example of the trampoline presented in FIG. 1,

FIG. 3 shows an example of attaching members,

FIG. 4 shows an example of a fastener member,

FIG. 5 shows an example how the fastener member of FIG. 4 is attached to the attaching members of FIG. 3,

FIG. 6 shows a second adjustment example of the trampoline presented in FIG. 1, and

FIG. 7 shows a third adjustment example of the trampoline presented in FIG. 1.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C”.

The embodiments in the following description are given as examples only and someone skilled in the art can carry out the basic idea of the invention also in some other way than what is described in the description. Though the description may refer to a certain embodiment or embodiments in several places, this does not mean that the reference would be directed towards only one described embodiment or that the described characteristic would be usable only in one described embodiment. The individual characteristics of two or more embodiments may be combined and new embodiments of the invention may thus be provided.

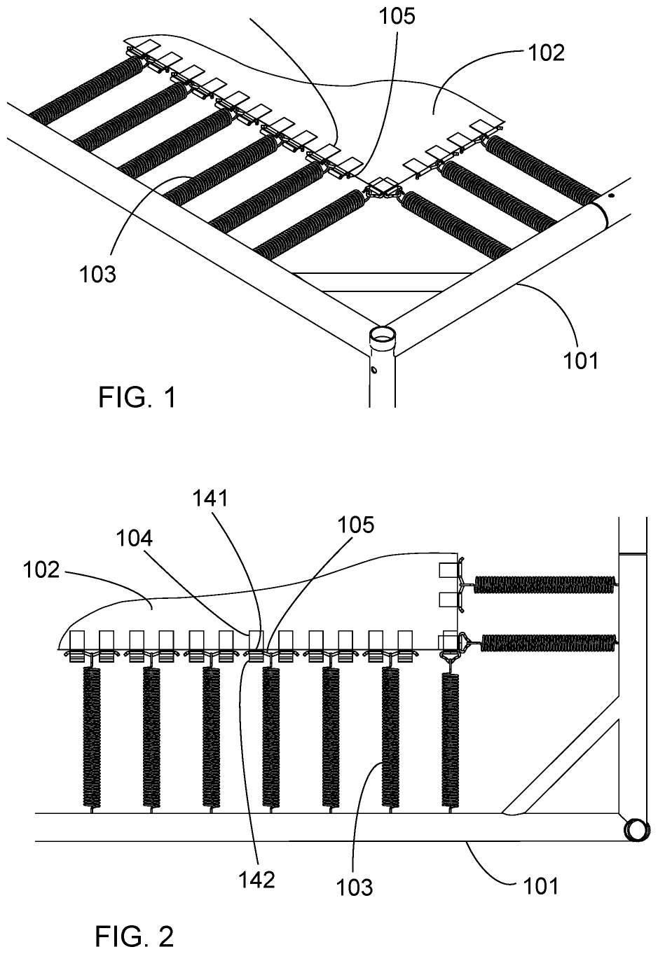

FIG. 1 shows an embodiment of a trampoline according to invention. The trampoline comprises a frame 101, a mat 102, and a plurality of spring elements 103 arranged between the mat and the frame. The frame comprises pipes and similar parts that form a supporting structure for the trampoline. In this embodiment, the mat and the frame are rectangular, but they can be circular, oval or elliptical. The mat is kept in its place with a multitude of spring elements 103 having elastic properties. These spring elements also provide the bouncing effect for the user of the trampoline. The spring element comprises a mat end and a frame end, and the mat end is attached to the mat and the frame end is attached to the frame. The ends of the spring element comprise some attaching arrangement, for example a hook. The spring elements are, for example, metal springs, rubber structures or other resilient members. The trampoline further comprises attaching members 104 and fastener members 105. The attaching members are fixed on the edge of the mat and the attaching members extends towards the frame from the edge of the mat.

The fastener member 105 is an elongated structure, for example a bar, which is attached at least to two adjacent attaching members in such a way that the fastener member is parallel to the edge of the mat. The fastener member comprises an anchor point for the mat end of the spring element 103, and the mat end of the spring element is attached to the anchor point. When the fastener member is attached to the attaching members, the anchor point is between said attaching members. In this embodiment, at the corner of the mat 102, the mat end of the spring element is connected to fixing elements that are shaped like rings or triangles. Said fixing elements are attached to one attaching member.

The attaching members 104 comprise casings that are hollow structures that are configured to receive the fastener members 105 for attaching the fastener members. The casings are parallel to the edge of the mat 102. The casings are configured in such a way that the fastoner members are detachable, and, naturally, fixable to the casings.

FIG. 2 shows the trampoline of FIG. 1 as seen above. In this embodiment, the attaching members 104 comprise two casings: an inner casing 141 and an outer casing 142. The casings are positioned in such a way that the distance from the inner casing 141 to the frame 101 is longer than the distance from the outer casing 142 to the frame, i.e. the inner casing is nearer to the mat 102 than the outer casing. In this Figure the fastener members 105 are placed inside the inner casings of two adjacent attaching member. The anchor point is between said attaching members. This means that between two adjacent spring elements 103, there are two attaching members. Of course, the fastener members and the spring elements can be positioned differently. It must be noted that all attaching members do not need two or more casings. In this embodiment, the side of the mat 102 that is vertical in Figure, comprises attaching members having only one casing. In some embodiments, only two opposing sides of the mat comprise attaching members having two or more casings.

The fastener member 105 is folded in such a way that the middle part and the ends of the fastener member are curved towards the frame 101, i.e. the fastener member has curves extending towards the frame. The folding is done in such a way that the curves are essentially at the same level.

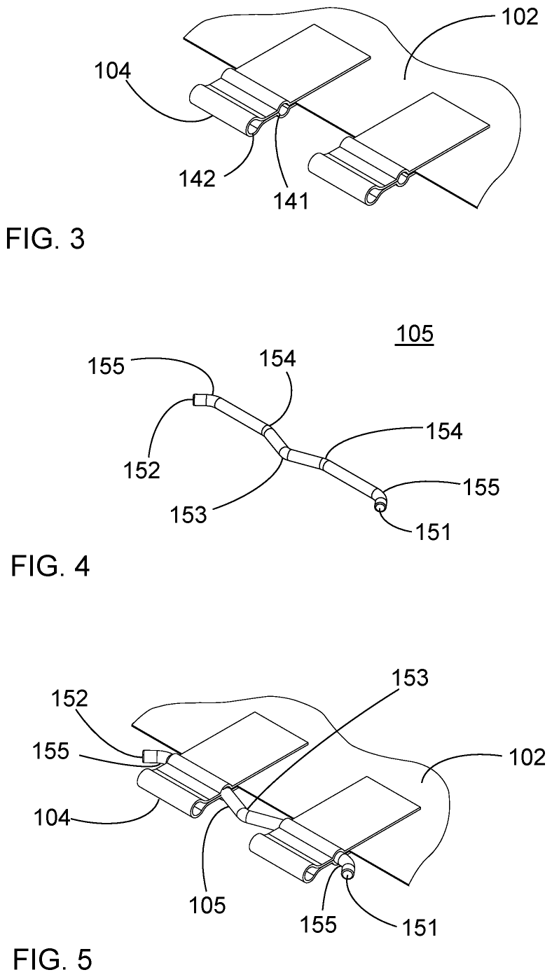

FIG. 3 shows an example of attaching members 104 presented in FIG. 1. The attaching members are fixed to the edge of the mat 102. The attaching member comprises the inner casing 141 and the outer casing 142. In this embodiment, the attaching member comprises a fabric loop that is fixed to the mat by sewing. The fabric loop is formed from a strip of fabric. One end of the strip is fixed on the upper surface of the mat, and another end of the strip is fixed on the lower surface of the mat. The middle part of the strip forms the part of the attaching member that extends towards frame 101 from the edge of the mat. The fabric in said extending part is folded in such a way that the fabric forms hollow casings. In some embodiments, the walls of the casings are hardened, or inside the casing there is some additional support structure. This is, for example, some reinforced material or a pipe. In some embodiments, the attaching member comprises more than two casings. Those additional casings are between the inner casing and the outer casing.

FIG. 4 shows an example of fastener members 105 presented in FIG. 1. The fastener member is an elongated bar having a first end 151 of the fastener member and a second end 152 of the fastener member. The material of the fastener member is some metal or a similar material. Advantageously, the fastener member is made of steel. In this embodiment, the fastener member is folded in such a way that the fastener member comprises five folds. The folds are a centre fold 153, two side folds 154 on both sides of the center fold, and two end folds 155. The end folds are near the first end of the fastener member and the second end of the fastener member, i.e. at both ends of the fastener member there is one end fold. In some embodiment, the fastener member comprises the center fold and two side folds. This means that the fastener member is straight between the ends of the fastener member and the side folds.

The side folds 154 are positioned in such a way that the distance between the side folds is substantially shorter than the distance between two adjacent attaching members. The end folds 155 are positioned in such a way that the distance between the end folds is longer than the distance between two adjacent attaching members. The center fold 153 and the side folds form a curve on the fastener member 105 and said curve curves towards the frame. This means that the center fold is closer to the frame than to the side folds. The center fold serves as the anchor point for the spring element.

The fold has an angle of the fold, and the angle of the fold is the angle between the fastener member parts adjacent to the fold. In this embodiment, the sum of the angles of the side folds 154 is substantially equal to the angle of the center fold. In some embodiments, the angle of the center fold 153 is between 30 and 45 degrees. In some embodiments, the angle of the end fold 155 is between 15 and 30 degrees.

In FIG. 5 is shown one example of how the fastener member 105 is attached to two adjacent attaching members 104. The positioning of fastener member is similar as was presented in FIGS. 1 and 2. The fastener member is attached to the inner casings and the outer casings are left empty. The fastener member is dimensioned in such a way that the first end 151 of the fastener member and the second end 152 of the fastener member extend over the sides of the attaching members. More precisely, the ends of the fastener member extend over the opposing sides of the adjacent attaching members. This means that the fastener member is longer than the distance between the opposing sides of the adjacent attaching members. The end folds 155 are positioned in such a way that they are inside the parts of the fastener member that extend over the opposing sides of the adjacent attaching members. The center fold 153 and the side folds are positioned in such a way that they are between the adjacent sides of the adjacent attaching members. This means that the parts of the fastener member that are inside the casings are straight.

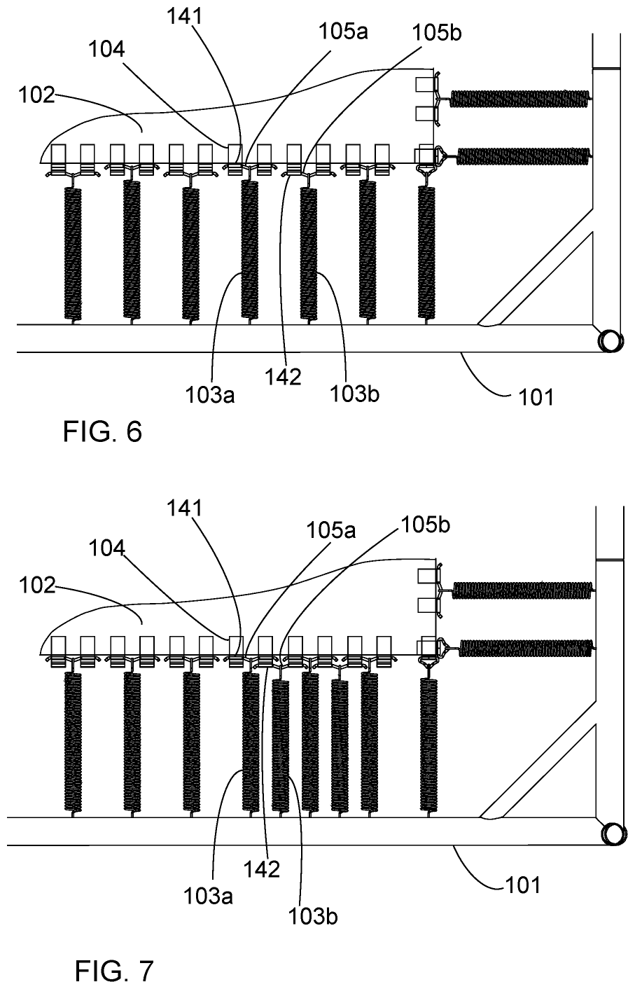

FIG. 6 shows a second example of the positioning of the spring elements 103 for adjusting the tension of the mat 102 of the trampoline. In this example, the adjacent fastener members 105 are attached to attaching members in different casings. One fastener member 105a is attached to the inner casings 141 of two adjacent attaching members 104. To the next two adjacent attaching members (a pair of attaching members that is adjacent to the previous pair of attaching members) is attached another fastener member 105b, and this fastener member is using the outer casings 142. This means that the adjacent spring elements have different anchor points. This example differs from the examples in FIGS. 1 and 2 in that some spring elements are not equally tight. FIG. 7 shows a third example of positioning of the spring elements 103 for adjusting the tension of the mat 102 of the trampoline. In this example, at least some of the adjacent fastener members 105 are attached to attaching members in different casings. This example differs from the previous positioning examples in that in some fastener members are attached to attaching members 104 in such a way that some attaching members have fastener members both on the inner casing 141 and the outer casing 142. This means that one spring element 103a is attached to the inner casings of two adjacent attaching members and second spring element is attached to the inner casings of next two adjacent attaching members. Between said spring elements is a third spring element 103b attached to the outer casings of two adjacent attaching members, and these attaching members are in common with the attaching member pairs of the spring element 103a and the second spring element. This means that two adjacent fastener members 105a, 105b are overlapping. One fastener member 105a is attached to the inner casings and another fastener member 105b is attached to the outer casings in such a way that they share the attaching member 104. This example makes it possible to increase the number of the spring elements in the trampoline.

Finally, it should be noted that the description of the invention and the exemplary embodiments are not to be understood as limiting in terms of a particular physical realisation of the invention. The scope of protection of the present invention is given by the claims and is not limited by the features illustrated in the description or shown in the figures.

1. A trampoline comprising:
a frame,
a mat, and
a plurality of spring elements arranged between the mat and the frame, and
wherein the spring element comprises a mat end and a frame end, and the mat comprises a plurality of attaching members (104) on the edge of the mat,
the trampoline further comprising a plurality of fastener members comprising an anchor point for the mat end of the spring element,
wherein at least some of the attaching members comprise two casings comprising an outer casing and an inner casing, the casings arranged to receive the fastener members and configured such that a distance from the inner casing to the frame is longer than the distance from the outer casing to the frame, and
wherein the fastener member is set into corresponding casings, such that outer casings or inner casings of the adjacent attaching members and the anchor point is between the adjacent attaching members.

2. The trampoline according to the claim 1, wherein the fastener member is an elongated bar having a first end of the fastener member and a second end of the fastener member, and the fastener member comprises at least three folds positioned such that the folded fastener member is substantially in the same plane, and the folds are a center fold and two side folds on both sides of the center fold.

3. The trampoline according to the claim 2, wherein the center fold and the side folds of the fastener member (105) are configured in such a way that the distance between the side folds is substantially shorter than the distance between two adjacent attaching members (104).

4. The trampoline according to the claim 3, wherein the fold has an angle which is the angle of the fastener member parts adjacent to the fold, and the sum of angles of the side folds is substantially equal to the angle of the center fold.

5. The trampoline according to claim 2, wherein an angle of the center fold is between 30 and 45 degrees.

6. The trampoline according to claim 2, wherein an anchor point is arranged at the center fold.

7. The trampoline according to claim 2, wherein the fastener member further comprises two end folds configured such that a distance between end folds is longer than a distance between two adjacent attaching members.

8. The trampoline according to the claim 7, where an angle of the end fold is between 15 and 30 degrees.

9. The trampoline according to claim 2, wherein folds of the fastener member are configured to form curves on the fastener member that curve towards the frame when the fastener member is positioned into casings.

10. The trampoline according to claim 1, wherein the fastener member is arranged between the adjacent attaching members either into the inner casings or the outer casings, and the fastener member is configured to be detachable, such that placing of the fastener member is interchangeable.

11. The trampoline according to claim 1, wherein tension of the mat is altered by changing a placing of at least some of the fastener members between the inner casings and the outer casings such that a distance of the fastener member and anchor point of the spring element varies in respect to the frame.

12. The trampoline according to claim 1, wherein tension of the mat is altered by varying the number of the spring elements and the tension is increased by arranging fastener members in at least some of every other space between adjacent attaching members such that adjacent fastener members are not occupying same casings.

13. The trampoline according to claim 1, wherein the fastener member is a steel bar.

14. The trampoline according to claim 1, wherein the attaching member comprises a fabric loop sewn onto the edge of the mat.

15. The trampoline according to the claim 14, wherein the fabric loop of the attaching member has at least two layers of fabric and the casings are formed between the layers.
